(19) United States
(12) Patent Application Publication
(10) Pub. No.: US 2024/0148014 A1
(43) Pub. Date: May 9, 2024

(54) CHOCOLATE AND CHOCOLATE CONFECTIONERY

(71) Applicant: WET Holdings (Global) Limited, Warwickshire (GB)

(72) Inventors: Michael ADAMS, Knowle (GB); Ahmed MOHAMED, Birmingham (GB)

(21) Appl. No.: 18/281,356

(22) PCT Filed: Mar. 11, 2022
(86) PCT No.: PCT/GB2022/050643

§ 371 Date: Sep. 11, 2023

(30) Foreign Application Priority Data
Mar. 11, 2021 (GB) 2103394.9

(51) Int. Cl. A23G 1/32; A23G 1/06; A23G 1/10

(52) U.S. Cl. CPC A23G 1/32; A23G 1/06; A23G 1/10

(57) ABSTRACT

In the present application, alkalization of cocoa natural products may be carried out by using a stable alkaline water (pH levels of up to 10.5 or more) with the aim to produce alkalized chocolate products with pleasant organoleptic, less sugar content, less acidity, high antioxidants contents, and addition of novel soluble ingredients to chocolate. This can be achieved by using the stable alkaline water produced by a Natralysis Process in alkalizing cocoa nibspre, during and post grinding, alkalizing the cocoa liquor and alkalizing the natural cocoa powder. The present application discloses a method or apparatus (3, 9, 15) in which a cocoa natural product and/or one or more of its derivatives is alkalized by using stable alkaline water.

### FIELD OF THE INVENTION

This application is related to methods, apparatus and formulations for processing and production of chocolate and chocolate confectioneries.

### BACKGROUND TO THE INVENTION

Chocolate is one of the most distributed and well-known products worldwide. Chocolate is produced from the cocoa pods collected from Theobroma cacao, which is also used to obtain different kinds of natural products: nibs, liquor, butter, cake, and powder. The word “nib” refers to unshelled and fermented cocoa seeds which are ground to produce a paste called cocoa liquor, which is employed to produce chocolate, ice cream, bakery products, drinks, and desserts. Apart from this cocoa mass being directly used, it can be pressed and divided into cake (solid part) and butter (oily part). Cocoa butter is used, in combination with sugar and liquor, to produce chocolate, and can also be used in confectionery fillings and different skin products. This product is introduced into the formulations of an assortment of cosmetic skin care products, and also, food products like confectionery, frozen desserts, dairy products, beverages, confectionery coating, bakery products, and instant premixes.

The natural cocoa powder is characterised by having a light colour, low solubility, and an acidic, astringent, and bitter taste. To darken its colour, reduce negative sensory characteristics, and improve cocoa solubility, an alkalization (or alkalinization) step can be incorporated.

Alkalization (or alkalinization), also known as “Dutching,” was a treatment first conceived by Coenraad Johannes van Houten in the 19th century to enhance cocoa powder solubility.

However, after its implementation, industry showed its capacity to modify flavour and colour, and started using it with cocoa nibs, liquors, and cakes.

Alkalization (or alkalinization) generally consists of mixing natural cocoa material with an alkali solution, and treating this mixture with the combined effects of temperature and pressure. The used alkali agent and its concentration depend on the desired cocoa properties and its end application. As alkali agents the following can be used separately or in a mixture: potassium hydroxide, potassium carbonate, sodium hydroxide, sodium carbonate, sodium bicarbonate, ammonium bicarbonate, ammonium hydroxide. Once a product is alkalized, it is no longer considered natural. Then according to its pH, it is classified as dark natural (pH 5 to 6), light (pH 6 to 7.2), medium (pH 7.2 to 7.6), or strong alkalized cocoa (pH>7.6). As expected, strong alkalized products possess darker colours, lower astringent, bitter and acidic notes, and more solubility.

In general, natural and light alkalized powders are used to prepare chocolates, ice creams, milk chocolate, coating, instant drink mixes, and fillings. Medium and strong alkalized cocoas are used overall in cookies, ice-creams, truffles, coatings, and cakes. Finally, black powders are used to prepare products with specific sensory characteristics, such as Oreo®-type biscuits.

However, the alkalization process has its disadvantages. For instance, alkalized process cocoa contains lower amounts of flavonols (antioxidants). The effect this has on nutritional value is disputed. One study determined that 60% of natural cocoa's original antioxidants were destroyed by light alkalization and 90% were destroyed by heavy alkalization. Therefore, an alternative method of alkalization is required to ensure high antioxidants are provided for consumers.

Additionally, chocolate products processed by dutching would still need the addition of large quantities of sugar to provide the landmark (or signature) sweet taste of chocolate for consumers. Unfortunately, the consumption of chocolate confectionery and products has been attributed as one of the key contributors of a number of ailments including diabetes, obesity, hypertension and others. Thus, an alternative method of alkalization is required to help provide the sweet flavour of chocolate but with less amount of used sugars.

In the present invention, we propose the employment of a stable alkaline water produced by the Natralysis Process—as described in PCT Patent Application publication Nos WO2019/243759 (International application no PCT/GB2019/000084) and WO2016128707 (International application no PCT/GB2016/000033) which are incorporated herein by reference as a method to alkalize cocoa natural products with the aim to deliver the advantages of cocoa alkalization but with high antioxidants contents, less sugar content and addition of novel soluble ingredients to chocolate. This can be achieved by using the stable alkaline water produced by the Natralysis Process in alkalizing the nibs pre, during and post grinding, alkalizing the chocolate liquor and alkalizing the natural cocoa powder.

We previously demonstrated that the Natralysis Process can produce stable alkaline water (from pH 7.1 to pH 10.5) which would remain stable regardless of the addition of ingredients. This would enable the alkalization of cocoa natural products to any levels up to 10.5 which would facilitate the production of chocolate products with various organoleptic properties, including the specialty pH 8 of Oreo® and beyond. This stable alkaline water may also act as a vehicle to blend antioxidants and other ingredients into the alkalized chocolate products which usually do not exist in alkalized chocolate products by dutching.

### STATEMENTS OF THE INVENTION

In the present invention, we propose the alkalization of cocoa natural products by using a stable alkaline water produced by the Natralysis Process—as described in WO2019/243759 and WO2016128707—with the aim to produce alkalized chocolate products with pleasant organoleptic, less sugar content, less acidity, high antioxidants contents, and addition of novel soluble ingredients to chocolate. This can be achieved by using the stable alkaline water produced by Natralysis Process in alkalizing the nibs pre, during and post grinding, alkalizing the chocolate liquor and alkalizing the natural cocoa powder.

We previously demonstrated that the Natralysis Process, as described in WO2019/243759 and WO2016128707, can produce stable alkaline water (from pH 7.1 to pH 10.5) in which the pH level would remain stable regardless of the addition of ingredients. This would enable the alkalization of cocoa natural products to any levels up to 10.5 which would facilitate the production of chocolate products with various organoleptic properties, including the speciality pH 8 of Oreo® and beyond. This stable alkaline water may also act as a vehicle to blend antioxidants and other ingredients into the alkalized chocolate products which usually do not exist in alkalized chocolate products by dutching.

In the present invention, alkalinization of the natural cocoa products may be achieved by any or some or all of the following ways:
Soaking the cocoa nibs with Natralysis Process produced stable alkaline water (any pH level up to 10.5 and beyond i.e. any alkaline pH level up to 10.5 and beyond) prior to grinding;
Adding Natralysis Process produced stable alkaline water (any pH level up to 10.5 and beyond i.e. any alkaline pH level up to 10.5 and beyond) to the cocoa nibs during grinding;
Mixing Natralysis Process produced stable alkaline water (any pH level up to 10.5 and beyond i.e. any alkaline pH level up to 10.5 and beyond) with cocoa nibs during a pressing stage for production of cocoa liquor and other chocolate products;
Adding Natralysis Process produced stable alkaline water (any pH level up to 10.5 and beyond i.e. any alkaline pH level up to 10.5 and beyond) to natural cocoa powder to formulate chocolate powder and other chocolate products.

The alkaline water produced by the Natralysis Process is stable regardless of the addition of ingredients including, but not limited to, antioxidants, vitamins, flavours, colouring agents, CBDs (Cannanidiols), THCs (Tetrahydrocannabinols), proteins, infusions, caffeine, solubilizers, stabilizers, emulsifiers, preservatives, collagens, seaweeds, and other ingredients. Thus, the chocolate products produced by alkalization with Natralysis Process produced alkaline water may have any or some or all of the aforementioned added ingredients.

The present invention may also enable the production of chocolate products with less added sugar while maintaining the pleasant sought after sweet organoleptics of chocolate which is desirable for consumers.

Alkaline waters produced by other methods including, but not limited to, electrolysis and naturally occurring alkaline water may also be used to alkalize natural cocoa products in accordance with the present invention.

According to one aspect, there is provided a method in which a cocoa natural product and/or one or more of its derivatives is alkalized by using alkaline water.

The alkaline water may have an alkaline pH level of up to 10.5 and beyond. The alkaline water may have a pH level from pH 7.1 to pH 10.5.

The cocoa natural product and/or one or more of its derivatives may include, but are not limited to, cocoa nibs, cocoa liquor, cocoa powder, cocoa related powder, chocolate powder, chocolate products and/or chocolate related products. The method may be used to process the cocoa natural product(s) and/or their derivative(s) and/or any one of the examples in the previous sentence.

The method may produce chocolate products with their signature or chocolate organoleptic (e.g. produces chocolate products with chocolate organoleptics).

The method may comprise soaking cocoa nibs in the alkaline water prior to grinding.

The method may comprise adding the alkaline water to cocoa nibs during grinding.

The method may comprise mixing the alkaline water with cocoa nibs during pressing to produce cocoa liquor and other chocolate products.

The method may comprise adding the alkaline water to natural cocoa powder to formulate chocolate powder and/or other chocolate products.

The stable alkaline water may act as a carrier to add an ingredient, preferably any one or more of: antioxidants, vitamins, flavours, colouring agents, CBDs, THCs, proteins, infusions, caffeine, solubilizers, stabilizers, emulsifiers, preservatives, collagens and seaweeds, to the cocoa natural product and/or its derivatives by alkalizing with the stable alkaline water. The ingredients in the previous sentence are examples and other ingredients may be added.

Sugar content may be reduced in chocolate production by alkalizing with the alkaline water while maintaining the signature chocolate organoleptic.

The alkaline water may be stable alkaline e.g. as produced by the Natralysis Process (e.g. by treatment of water using solid particulate or granular material comprising one or more elementary metals or oxides thereof capable of raising the pH of the water)

The alkaline water may be produced by ionisation, electrolysis, or chemical reaction or may be naturally occurring alkaline water.

A PLC and its software may be programmed with an algorithm and used in the method to control, maintain and adjust the alkalization process by computing data information from a plurality of probes or sensors as well as an amount of the cocoa natural product and/or derivatives, and the desired chemical, physical and organoleptic properties of the alkalized cocoa or chocolate product produced by the method.

According to another aspect, there is provided an apparatus in which a cocoa natural product and/or one or more of its derivatives is alkalized by using alkaline water.

The alkaline water may have an alkali pH level of up to 10.5 and beyond.

The alkaline water may have a pH level from pH 7.1 to pH 10.5.

The cocoa natural product and/or one or more of its derivatives may be cocoa nibs, cocoa liquor, cocoa powder, cocoa related powder, chocolate powder, chocolate products and/or chocolate related products.

The alkalization may produce chocolate products with their signature or chocolate organoleptic.

The apparatus may comprise a soaking vessel in which cocoa nibs are soaked in the alkaline water prior to grinding.

The apparatus may comprise a grinding container or vessel in which cocoa nibs are ground, the apparatus being arranged to add the alkaline water to the grinding container or vessel.

The apparatus may comprise a vessel in which cocoa nibs are pressed to produce cocoa liquor, the apparatus being arranged to add the alkaline water to the vessel.

The apparatus may be arranged to add alkaline water to natural cocoa powder to formulate chocolate powder and other chocolate products.

The alkaline water may act as a carrier to add an ingredient, preferably any one or more of: antioxidants, vitamins, flavours, colouring agents, CBDs, THCs, proteins, infusions, caffeine, solubilizers, stabilizers, emulsifiers, preservatives, collagens and seaweeds to the cocoa natural product or its derivatives by alkalizing with the alkaline water. The ingredients in the previous sentence are examples and other ingredients may be added.

Sugar content may be reduced in chocolate production by alkalizing with the alkaline water while maintaining the signature chocolate organoleptic.

The alkaline water may be stable alkaline e.g. as produced by the Natralysis Process (e.g. by treatment of water using solid particulate or granular material comprising one or more elementary metals or oxides thereof capable of raising the pH of the water)

The alkaline water may be produced by ionisation, electrolysis, or chemical reaction or may be naturally occurring alkaline water.

The apparatus may further comprise a PLC having software, the PLC and the software being programmed with an algorithm configured to control, maintain and adjust the alkalization process by computing data information from a plurality of probes or sensors as well as an amount of the cocoa natural product and/or derivatives, and the desired chemical, physical and organoleptic properties of the alkalized cocoa or chocolate product produced by the apparatus.

### BRIEF DESCRIPTION OF THE DRAWINGS

The accompanying drawings are:

FIG. 1 is a diagrammatic flow chart of the steps of chocolate processing and alkalization stages in accordance with the present invention;

FIG. 2 is a diagrammatic presentation of soaking of cocoa nibs by alkalization machinery in accordance with the present invention;

FIG. 3 is a diagrammatic presentation of cocoa nibs grinding by alkalization machinery in accordance with present invention; and

FIG. 4 is a diagrammatic presentation of cocoa liquor production by alkalization machinery in accordance with the present invention.

### DETAILED DESCRIPTION OF THE INVENTION

The invention will now be described, by way of example, with reference to the accompanying drawings.

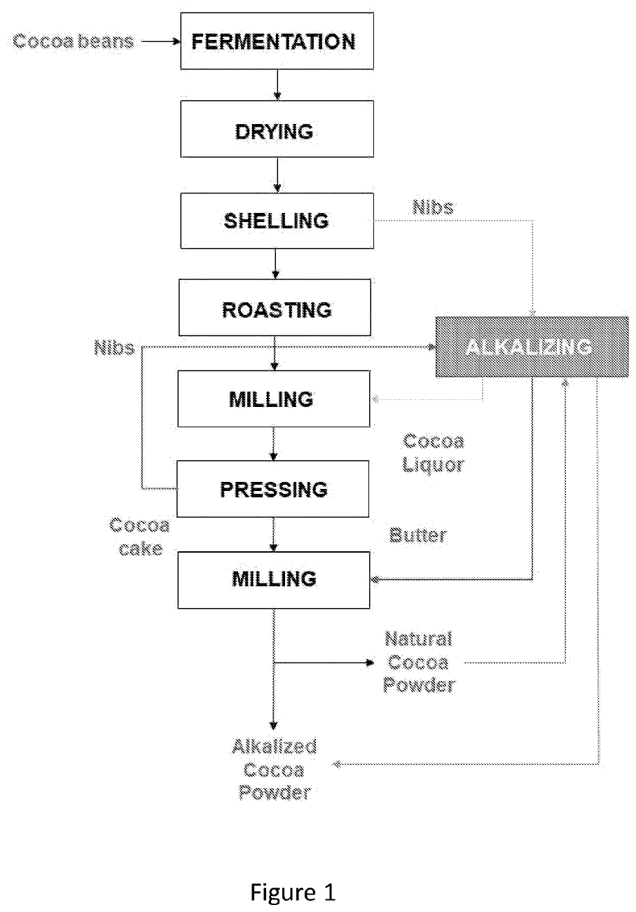

Referring to FIG. 1 of the accompanying drawings, the alkalization of cocoa, cocoa natural products including, but not limited to, cocoa nibs, cocoa cakes and cocoa liquor, cocoa powder and cocoa related powder in the present invention may be carried out by using a stable alkaline water produced by the Natralysis Process (e.g. by treatment of water using solid particulate or granular material comprising one or more elementary metals or oxides thereof capable of raising the pH of the water)—as described in WO2019/243759 and WO2016128707. The methods and apparatuses described in the present application may produce alkalized chocolate products with pleasant organoleptic, less sugar content, less acidity, high in antioxidants contents, and added novel soluble ingredients to chocolate. This may be achieved by using the stable alkaline water produced by Natralysis Process in alkalizing the nibspre, during and post grinding, alkalizing the chocolate liquor and alkalizing the natural cocoa powder and cocoa powder related products.

Alkalinization of the natural cocoa products, with reference to FIG. 1, may be achieved by any or some or all of the following ways:
Soaking the cocoa nibs with Natralysis Process produced stable alkaline water (any pH level up to 10.5 and beyond i.e. any alkaline pH level up to 10.5 and beyond) prior to grinding;
Adding Natralysis Process produced stable alkaline water (any pH level up to 10.5 and beyond i.e. any alkaline pH level up to 10.5 and beyond) to the cocoa nibs during grinding;
Mixing Natralysis Process produced stable alkaline water (any pH level up to 10.5 and beyond i.e. any alkaline pH level up to 10.5 and beyond) with cocoa nibs during the pressing stage for production of cocoa liquor and other chocolate products;
Adding Natralysis Process produced stable alkaline water (any pH level up to 10.5 and beyond i.e. any alkaline pH level up to 10.5 and beyond) to natural cocoa powder to formulate chocolate powder and other chocolate products.

Soaking the cocoa nibs with Natralysis Process stable alkaline water (any pH level up to 10.5 and beyond i.e. any alkaline pH level up to 10.5 and beyond) prior to grinding may be achieved manually or by machinery. Manually, cocoa nibs may be soaked by dipping or covering the cocoa nibs under a bed of alkaline water produced by Natralysis Process. The pH of the alkaline water used in the alkalization process controlled by the Natralysis Process as described in WO2019/243759 and WO2016128707. On the other hand, the volume, temperature of the alkaline water and the time by which the cocoa nibs are soaked may all be adjusted manually. Preferably, the manual soaking of the cocoa nibs in Natralysis Process produced alkaline water may be performed by using equipment and componentry commonly used for manual soaking of cocoa nibs for alkalisation purposes. The manual cocoa nibs soaking by the Natralysis Process produced alkaline water in the present invention may be controlled by various soaking factors including, but not limited to, the amount of cocoa nibs being soaked, alkaline water pH level, pressure, temperature, volume, the chemical and physical properties of the alkaline water and the duration time of cocoa nibs soak in the Natralysis Process produced alkaline water which are all considered in an algorithm or process condition charts which also consider the desired chemical, physical, and organoleptic properties of the cocoa nibs after alkalization as well as the final cocoa related products and chocolate products and other factors.

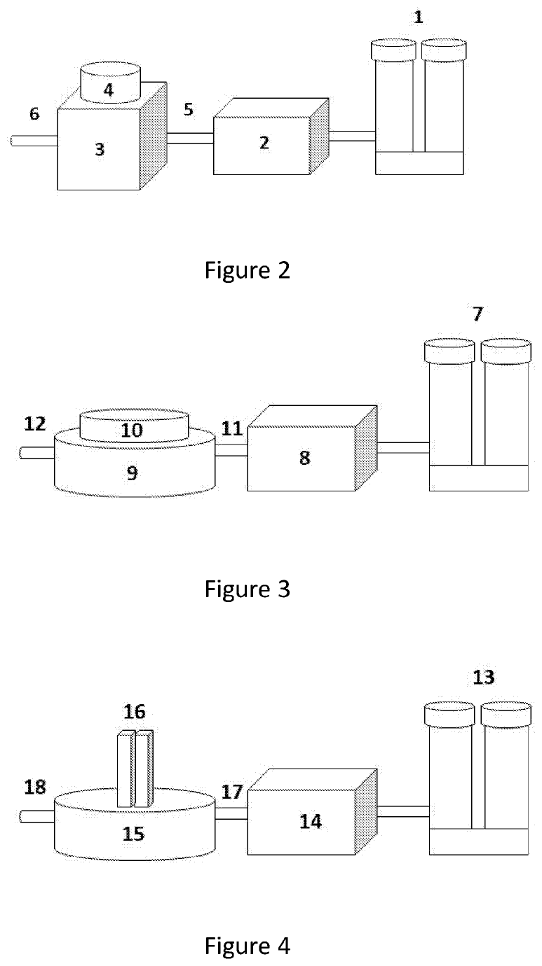

Alternatively, with reference to FIG. 2 of the accompanying drawings, soaking of the cocoa nibs in Natralysis Process produced water (any pH level up to 10.5 and beyond i.e. any alkaline pH level up to 10.5 and beyond) may be carried out by an apparatus or machinery which are commonly used for soaking cocoa nibs for alkalization purposes. Also, soaking of cocoa nibs in Natralysis Process produced alkaline water may be carried out by an apparatus or machinery 3 which comprises componentry similar to apparatuses or machinery commonly used for soaking cocoa nibs for alkalization purposes but may be manufactured or modified to enable alkalization of cocoa nibs under soaking controlled condition including, but not limited to, quantity controlled addition or pouring of cocoa nibs into an enclosed soaking vessel 4 that may also be provided by access points for pouring or pumping in via pipes or hoses 5 alkaline water produced by Natralysis Process. The said soaking vessel 4 may also be provided by means for gentle stirring or mixing of the soaked or covered cocoa nibs inside the alkaline water. The alkaline water may be removed from the said soaking vessel manually or pumped out via pumping pipes/hoses 6 that may be connected to the soaking vessel. The said pipes/hoses may be provided with a sieve/mesh filter to prevent cocoa nibs from getting poured out or pumped out of the soaking vessel. The alkaline water produced by the Natralysis Process machine 1 may be caused to pour in or be pumped into the said soaking vessel from a water treatment container or vessel 2 that stores and treats the alkaline water prior to being poured in or pumped in to the said soaking vessel 4. The said water treatment container or vessel 2 may be provided by means of water temperature adjustments, water pressure adjustment, water volume adjustments, and other means for adjustments of water chemical and physical properties. The said water treatment container or vessel 2 may also be provided by probes and/or sensors to detect or measure water chemical and physical properties including, but not limited to, water pH, temperature, pressure, volume, conductivity, and others. The readings of the aforementioned probes/sensors may be visualised by a PLC (programmable logic controller) via a digital monitor locally or remotely and enable the operator to adjust the water chemical and physical properties by the said water treatment container or vessel 2. Additionally, the soaking vessel 4 may also be provided by means of water temperature adjustments/treatment, water pressure adjustment, water volume adjustments, and other means for adjustments of water chemical and physical properties. The soaking vessel 4 may also be provided by probes and/or sensors to detect or measure water chemical and physical properties including, but not limited to, water pH, temperature, pressure, volume, conductivity, and others. The readings of the aforementioned probes/sensors may be visualised by a PLC digital monitor locally or remotely and enable the operator to adjust the water chemical and physical properties by the said water soaking vessel 4. The alkaline water pH level may be controlled by the Natralysis Process machine as described in WO2019/243759 and WO2016128707. The cocoa nibs soaking in Natralysis Process produced alkaline water by an apparatus or machinery, in accordance with the present invention, may be controlled by the aforementioned PLCs which are equipped by software which is programmed to an algorithm that considers various factors including, but not limited to, the amount of cocoa nibs being soaked, the alkaline water pH level, pressure, temperature, volume, the chemical and physical properties of the alkaline water and the duration time of cocoa nibs soaking in the Natralysis Process produced alkaline water as well as the desired chemical, physical, and organoleptic properties of the cocoa nibs after alkalization as well as the final cocoa related products and chocolate products.

Cocoa nibs may be alkalized by the Natralysis Process stable alkaline water (any pH level up to 10.5 and beyond i.e. any alkaline pH level up to 10.5 and beyond) during cocoa nibs grinding process manually or by machinery. Manually, alkaline water produced by the Natralysis Process may be added or poured in manually into the cocoa nibs grinding machine. This process may be carried out by equipment or componentry or machinery which are commonly used for cocoa nibs grinding for chocolate processing. The manual alkalization of cocoa nibs during grinding by the Natralysis Process produced alkaline water in the present invention may be controlled by various soaking and/or grinding factors including, but not limited to, the amount of cocoa nibs being ground, alkaline water pH level, pressure, temperature, volume, the chemical and physical properties of the alkaline water and the duration time of cocoa nibs ground in the Natralysis Process produced alkaline water which are all considered in an algorithm or process condition charts which also consider the desired chemical, physical, and organoleptic properties of the cocoa nibs after alkalization as well as the final cocoa related products and chocolate products and other factors.

Alternatively, with reference to FIG. 3 of the accompanying drawings, alkalization of cocoa nibs during grinding, in accordance with the present invention, may be carried by apparatus or machinery commonly used in the industry for cocoa nibs grinding. Additionally, alkalization of cocoa nibs during grinding, in accordance with the present invention, may also be carried by an apparatus or machinery 9 and 10 which comprises componentry similar to apparatuses or machinery commonly used for grinding cocoa nibs but may also be manufactured or modified to ensure cocoa nibs grinding as well as alkaline water alkalization being carried out under controlled conditions. Similar to all cocoa nibs grinding machines, the machinery 9 in the present invention comprises enclosed grinding container or vessel 10 whereby controlled quantities of cocoa nibs are added or poured in. The said grinding container or vessel 10 may be provided by means of grinding (continuous or intermittent grinding) including grinding stones and others. The said grinding container or vessel 10 may also be provided by means that enable container or vessel 10 rotation similar to some cocoa nibs grinding machines. The grinding container or vessel 10, in the present invention, may be provided by access points whereby controlled volumes of alkaline water from Natralysis process 7 machine may be poured in or pumped in 11 from a nearby water treatment container or vessel 8. The said water treatment container or vessel 8 may store the alkaline water produced by the Natralysis Process machine 7 and may further treat the alkaline water by adjusting its temperature, pressure, or any other water chemical or physical properties. Thus, the said water treatment container or vessel 8 may be provided by means of water temperature adjustment, water pressure adjustment, and/or any means to adjust the chemical and/or physical properties of the alkaline water. The said water treatment container or vessel 8 may also be provided by probes or sensors to detect or measure the alkaline water chemical and physical properties including, but not limited to, water pH, temperature, pressure, volume, conductivity, and others. The readings of the aforementioned probes/sensors may be visualised by a PLC digital monitor locally or remotely and enable the operator to adjust the water chemical and physical properties by the said water chemical and physical properties adjustment means in the said water treatment container or vessel 8. The alkaline water pH level is controlled by the Natralysis Process machine as described in WO2019/243759 and WO2016128707. Additionally, the said enclosed grinding container or vessel 10 may be provided by means of water temperature and/or pressure adjustments. The said enclosed grinding container or vessel 10 may also be provided by probes or sensors to detect or measure water chemical and physical properties including, but not limited to, water pH, temperature, pressure, and others. The readings of the aforementioned probes/sensors may be visualised by a PLC digital monitor locally or remotely and enable the operator to adjust the water chemical and physical properties by the said water chemical and physical properties adjustment means in the said water treatment container or vessel. Also, the said enclosed grinding container or vessel 10 may be provided by means of pouring out or pumping out the alkaline water by pipes or hoses 12 that may be connected to the grinding container or vessel. The alkalization of cocoa nibs during grinding by an apparatus or machinery 9 and 10, in accordance with the present invention, may be controlled by the aforementioned PLCs which are equipped by software which is programmed to an algorithm that considers various factors including, but not limited to, the amount of cocoa nibs being ground, grinding force, the alkaline water pH level, pressure, temperature, volume, the chemical and physical properties of the alkaline water and the duration time of cocoa nibs grinding with the Natralysis Process machine 7 produced alkaline water as well as the desired chemical, physical, and organoleptic properties of the ground cocoa nibs after alkalization as well as the final cocoa related products and chocolate products.

Alkalization may take place by mixing alkaline water produced by Natralysis Process (any pH level up to 10.5 and beyond i.e. any alkaline pH level up to 10.5 and beyond) with Cocoa nibs during a pressing stage, also known as cocoa liquor production stage, of chocolate processing manually or by machinery. Manually, alkaline water produced by the Natralysis Process may be added or poured in manually into the cocoa nibs during pressing or cocoa liquor production. This process may be carried out by equipment or componentry or machinery which are commonly used for cocoa liquor of chocolate processing. The manual alkalization of cocoa nibs by the Natralysis Process produced alkaline water during the pressing stage, in accordance with the present invention, may be controlled by various cocoa nibs pressing factors including, but not limited to, the amount of cocoa nibs being pressed, pressing force, alkaline water pH level, pressure, temperature, volume, the chemical and physical properties of the alkaline water and the duration time of cocoa nibs pressing in the Natralysis Process produced alkaline water which are all considered in an algorithm or process condition charts which also consider the desired chemical, physical, and organoleptic properties of the pressed cocoa nibs after alkalization as well as the final cocoa related products and chocolate products and other factors.

Alternatively, with reference to FIG. 4 of the accompanying drawings, an apparatus or machinery may be manufactured to ensure alkaline water produced by Natralysis Process is properly mixed with cocoa nibs under controlled condition during pressing or cocoa liquor production stage. This may be carried out by apparatus or machinery commonly used in the industry for cocoa nibs pressing purposes. Additionally, an apparatus or machinery 15 and 16, in accordance with the present invention, may comprise a compartment or a vessel 16 whereby controlled quantities of cocoa nibs are added or poured in for pressing. The apparatus or machinery 15 and 16 may comprise componentry similar to apparatuses or machinery commonly used for cocoa liquor production but may also be modified to comprise the vessel 16. This compartment or vessel 16 comprises all the equipment and machinery commonly used for pressing cocoa nibs to produce cocoa liquor. Additionally, the said pressing compartment or vessel 16 may comprise access points whereby controlled volumes of Natralysis Process 13 produced alkaline water may be poured in or pumped in to the compartment or vessel 16 during the pressing process via pipes/hoses 17 and from a water treatment vessel 14. The said water treatment vessel 14 stores and treats the alkaline water produced by the Natralysis Process machine 13 prior to being poured in or pumped in to the said pressing compartment or vessel 16. The said water treatment vessel 14 may be provided by means of water temperature adjustments, water pressure adjustment, water volume adjustments, and other means for adjustments of water chemical and physical properties. The said water treatment vessel 14 may also be provided by probes and/or sensors to detect or measure water chemical and physical properties including, but not limited to, water pH, temperature, pressure, volume, conductivity, and others. The readings of the aforementioned probes/sensors may be visualised by a PLC digital monitor locally or remotely and enable the operator to adjust the water chemical and physical properties by the said water treatment vessel 14. Additionally, the pressing compartment or vessel 16 may also be provided by means of water temperature adjustments/treatment, water pressure adjustment, water volume adjustments, and other means for adjustments of water chemical and physical properties. The pressing vessel 16 may also be provided by probes and/or sensors to detect or measure water chemical and physical properties including, but not limited to, water pH, temperature, pressure, volume, conductivity, and others. The readings of the aforementioned probes/sensors may be visualised by a PLC digital monitor locally or remotely and enable the operator to adjust the water chemical and physical properties by the said pressing compartment or vessel 16. The alkaline water pH level is controlled by the Natralysis Process machine 13 as described in WO2019/243759 and WO2016128707. The alkalization of cocoa nibs during pressing by an apparatus or machinery 15 and 16, in accordance with the present invention, may be controlled by the aforementioned PLCs which are equipped by software which is programmed to an algorithm that considers various factors including, but not limited to, the amount of cocoa nibs being pressed, pressing force, the alkaline water pH level, pressure, temperature, volume, the chemical and physical properties of the alkaline water and the duration time of cocoa nibs pressing with the Natralysis Process produced alkaline water as well as the desired chemical, physical, and organoleptic properties of the pressed cocoa nibs after alkalization as well as the final cocoa related products and chocolate products.

Alkalization may also be carried out by adding Natralysis Process stable alkaline water (any pH level up to 10.5 and beyond i.e. any alkaline pH level up to 10.5 and beyond) to natural cocoa powder to formulate chocolate powder and other chocolate products, with reference to FIG. 1 of the accompanying drawings. The process of natural cocoa powder and the use of cocoa powder and chocolate powder to produce chocolate and chocolate products requires the use of water. In the present invention, alkaline water from the Natralysis process may be added and/or mixed with natural cocoa powder or any other cocoa derived powder used in chocolate production or any other chocolate related products. This addition of Natralysis Process alkaline water to the cocoa powder or cocoa related powder may also be carried out manually or by machinery. Manually, alkaline water produced by Natralysis process may manually be poured in or added to cocoa powder or any other cocoa related powder for chocolate powder and/or chocolate or chocolate related products production. This process may be carried out by equipment or componentry or machinery which are commonly used for cocoa or chocolate powder mixing. For the latter purposes, the alkaline water produced by Natralysis process may be stored or treated in a water treatment container or vessel prior to addition to the cocoa powder or cocoa related powder or chocolate powders. The said water treatment container or vessel may be provided by measures for adjusting water chemical and physical properties including, but not limited to, pH, temperature, pressure, volumes and others. Also, the said water treatment or vessel may be provided by probes or sensors to detect or measure the chemical and physical properties of the alkaline water produced Natralysis process including, but not limited to, water pH, temperature, pressure, volume, conductivity, and others. The readings of the aforementioned probes/sensors may be visualised by a PLC monitor locally or remotely and enable the operator to adjust the water chemical and physical properties by the said water treatment container or vessel. The alkaline water pH level may be controlled by the Natralysis Process machine as described in patents WO2019/243759 and WO2016128707. The manual mixing of the cocoa powder or chocolate powder with the Natralysis Process produced alkaline water, in accordance with the present invention, may be controlled by various mixing factors including, but not limited to, the amount of cocoa powder or chocolate powder, the chemical and physical properties of cocoa powder or chocolate powder, mixing force, mixing time, alkaline water pH level, pressure, temperature, volume, the chemical and physical properties of the alkaline water and the duration time of mixing with in the Natralysis Process produced alkaline water which are all considered in an algorithm or process condition charts which also consider the desired chemical, physical, and organoleptic properties of the cocoa powder, chocolate powder, chocolate products and other factors.

Alternatively, adding of Natralysis Process stable alkaline water to cocoa powder or cocoa related powder or chocolate powder for the production of chocolate or any chocolate related product may be carried out by machinery. Machinery commonly used in the industry for the use of cocoa powder or cocoa related powder or chocolate powder may be used. Additionally, apparatus or machinery may be manufactured, in accordance with the present invention, which may comprise componentry similar to apparatuses or machinery commonly used for cocoa powder mixing but may also be modified to be provided by equipment or componentry that facilitates controlled pouring in or pumping in Natralysis Process alkaline water into the mixing area or machinery from the a water treatment container or vessel. The said water treatment container or vessel stores and or treats the Natralysis Process alkaline water and may be provided by measures to adjust the chemical and physical properties of alkaline water including, but not limited to, water pH, conductivity, temperature, pressure, volume and others. The said water treatment container or vessel may be provided by probes or sensors to detect and measure the chemical and physical properties of the alkaline water produced by Natralysis process including, but not limited to, water pH, temperature, pressure, volume, conductivity, and others. The readings of the aforementioned probes/sensors may be visualised by a PLC digital monitor locally or remotely and enable the operator to adjust the water chemical and physical properties by the said water treatment container or vessel. The alkaline water pH level is controlled by the Natralysis Process machine as described in WO2019/243759 and WO2016128707. The mixing of cocoa powder or chocolate powder with Natralysis Process produced alkaline water by an apparatus or machinery, in accordance with the present invention, may be controlled by the aforementioned PLCs which are equipped by software which is programmed to an algorithm that considers various factors including, but not limited to, the amount of cocoa powder or chocolate powder being mixed, mixing force, mixing time, the chemical and physical properties of the cocoa powder or chocolate powder, the alkaline water pH level, pressure, temperature, volume, the chemical and physical properties of the alkaline water and the duration time of mixing of cocoa powder or chocolate powder with the Natralysis Process produced alkaline water as well as the desired chemical, physical, and organoleptic properties of the cocoa powder, chocolate powder, chocolate and chocolate products.

The alkaline water produced by the Natralysis Process is stable in which the alkaline pH levels remain stable regardless of the addition of ingredients including, but not limited to, antioxidants, vitamins, flavours, colouring agents, CBDs, THCs, proteins, infusions, caffeine, solubilizers, stabilizers, emulsifiers, preservatives, collagens, seaweeds, and other ingredients. Thus, in this present invention, the aforementioned ingredients may be added to the cocoa nibs, cocoa liquor, cocoa powder or chocolate powder or chocolate or chocolate related products by adding them to the alkaline water produced by the Natralysis Process. The alkaline water, in this example, will act as a carrier to add the aforementioned ingredients into cocoa nibs, cocoa liquor, cocoa powder or chocolate powder or chocolate or chocolate related products by using the alkalisation methods, componentry and apparatuses/machinery described in the present application.

This present invention may also enable the production of chocolate products with less added sugar while maintaining the pleasant sought after sweet organoleptics of chocolate which is desirable for consumers.

Alkaline waters produced by other methods including, but not limited to, electrolysis and naturally occurring alkaline water may also be used in the methods, componentry and apparatuses/machinery described in the present application.

The following clauses set out embodiments and/or aspects of the present disclosure:

Clause 1. A method or an apparatus in which cocoa natural products and its derivatives including, but not limited to, cocoa nibs, cocoa liquor, cocoa powder, cocoa related powder, chocolate powder, chocolate products and/or chocolate related products may be alkalized by using stable alkaline water (any pH level up to 10.5 and beyond) which produce chocolate products with their signature organoleptic.

Clause 2. A method or an apparatus according to Clause 1, wherein soaking the cocoa nibs in stable alkaline water (any pH level up to 10.5 and beyond) prior to grinding.

Clause 3. A method or an apparatus according to Clause 1 or Clause 2, wherein adding stable alkaline water (any pH level up to 10.5 and beyond) to the cocoa nibs during grinding.

Clause 4. A method or apparatus according to any of the preceding Clauses, wherein mixing stable alkaline water (any pH level up to 10.5 and beyond) with cocoa nibs during pressing to produce cocoa liquor production and other chocolate products.

Clause 5. A method or apparatus according to any of the preceding Clauses, wherein adding stable alkaline water (any pH level up to 10.5 and beyond) to natural cocoa powder to formulate chocolate powder and other chocolate products.

Clause 6. A method or apparatus according to any of the preceding Clauses, wherein antioxidants, vitamins, flavours, colouring agents, CBDs, THCs, proteins, infusions, caffeine, solubilizers, stabilizers, emulsifiers, preservatives, collagens, seaweeds, and other ingredients are added to cocoa natural products and chocolate products by alkalizing with stable alkaline water (any pH level up to 10.5 and beyond) formulated by addition of aforementioned ingredients.

Clause 7. A method or an apparatus according to any of the preceding Clauses, wherein sugar content may be reduced in chocolate production by alkalizing with stable alkaline water (any pH level up to 10.5 and beyond) while maintaining the signature chocolate organoleptic.

Clause 8. A method or an apparatus according to any of the preceding Clauses, wherein alkaline water produced by ionisation or electrolysis or chemical reaction or naturally occurring alkaline water may be used to alkalize cocoa nibs, cocoa liquor, cocoa powder, chocolate powder or in chocolate processing and production.

1-26. (canceled)

27. A method in which a cocoa natural product and/or one or more of its derivatives is alkalized by using alkaline water wherein said alkaline water is produced by treatment of water using solid particulate or granular material comprising one or more elementary metals or oxides thereof capable of raising the pH of the water.

28. The method according to claim 27, wherein the alkaline water has a pH level from pH 7.1 to pH 10.5.

29. The method according to claim 27, wherein the cocoa natural product and/or one or more of its derivatives include, but are not limited to, cocoa nibs, cocoa liquor, cocoa powder, cocoa related powder, chocolate powder, chocolate products and/or chocolate related products.

30. The method according to claim 27, wherein the method produces chocolate products with their signature or chocolate organoleptic.

31. The method according to claim 27, wherein the method comprises soaking cocoa nibs in the alkaline water prior to grinding.

32. The method according to claim 27, wherein the method comprises adding the alkaline water to cocoa nibs during grinding.

33. The method according claim 27, wherein the method comprises mixing the alkaline water with cocoa nibs during pressing to produce cocoa liquor and other chocolate products.

34. The method according to claim 27, wherein the method comprises adding alkaline water to natural cocoa powder to formulate chocolate powder and/or other chocolate products.

35. The method according to claim 27, wherein the alkaline water acts as a carrier to add an ingredient, preferably any one or more of: antioxidants, vitamins, flavours, colouring agents, CBDs, THCs, proteins, infusions, caffeine, solubilizers, stabilizers, emulsifiers, preservatives, collagens and seaweeds to the cocoa natural product or its derivatives by alkalizing with the stable alkaline water.

36. The method according to claim 27, wherein sugar content is reduced in chocolate production by alkalizing with the alkaline water while maintaining the signature chocolate organoleptic.

37. The method according to claim 27, wherein the alkaline water is stable alkaline water.

38. The method according to claim 27, wherein a PLC and its software are programmed with an algorithm which controls, maintains and adjusts the alkalization process by computing data information from a plurality of probes or sensors as well as an amount of the cocoa natural product and/or derivatives, and the desired chemical, physical and organoleptic properties of the alkalized cocoa or chocolate product produced by the method.

39. An apparatus in which a cocoa natural product and/or one or more of its derivatives is alkalized by using alkaline water wherein said alkaline water is produced by treatment of water using solid particulate or granular material comprising one or more elementary metals or oxides thereof capable of raising the pH of the water.

40. The apparatus according to claim 39, wherein the alkaline water has a pH level from pH 7.1 to pH 10.5.

41. The apparatus according to claim 39, wherein the cocoa natural product and/or one or more of its derivatives include, but are not limited to, cocoa nibs, cocoa liquor, cocoa powder, cocoa related powder, chocolate powder, chocolate products and/or chocolate related products.

42. The apparatus according to claim 39, wherein the alkalization produces chocolate products with their signature or chocolate organoleptic.

43. The apparatus according to claim 39, the apparatus comprising a soaking vessel in which cocoa nibs are soaked in the stable alkaline water prior to grinding.

44. The apparatus according to claim 39, the apparatus comprising a grinding container or vessel in which cocoa nibs are ground, the apparatus being arranged to add the alkaline water to the grinding container or vessel during cocoa nibs grinding.

45. The apparatus according to claim 39, the apparatus comprising a vessel in which cocoa nibs are pressed to produce cocoa liquor, the apparatus being arranged to add the alkaline water to the vessel during cocoa nibs pressing.

46. The apparatus according to claim 39, wherein the apparatus is arranged to add the alkaline water to natural cocoa powder to formulate chocolate powder and other chocolate products.

47. The apparatus according to claim 39, wherein the stable alkaline water acts as a carrier to add an ingredient, preferably any one or more of: antioxidants, vitamins, flavours, colouring agents, CBDs, THCs, proteins, infusions, caffeine, solubilizers, stabilizers, emulsifiers, preservatives, collagens and seaweeds to the cocoa natural product or its derivatives by alkalizing with the alkaline water.

48. The apparatus according to claim 39, wherein sugar content is reduced in chocolate production by alkalizing with the alkaline water while maintaining the signature or chocolate organoleptic.

49. The apparatus according to claim 39, wherein the alkaline water is stable alkaline water.

50. The apparatus according to claim 39, further comprising a PLC having software, the PLC and the software being programmed with an algorithm configured to control, maintain and adjust the alkalization process by computing data information from a plurality of probes or sensors as well as an amount of the cocoa natural product and/or derivatives, and the desired chemical, physical and organoleptic properties of the alkalized cocoa or chocolate product produced by the apparatus.
